(19) United States
(12) Patent Application Publication
(10) Pub. No.: US 2026/0067294 A1
(43) Pub. Date: Mar. 5, 2026

(54) ALERT MANAGEMENT FOR DATA PROCESSING SYSTEMS USING OUT-OF-BAND METHODS

(71) Applicant: Dell Products L.P., Round Rock, TX (US)

(72) Inventors: ABEYE TESHOME, Austin, TX (US); RICHARD M. TONRY, Georgetown, TX (US); BASSEM EL-AZZAMI, Austin, TX (US); MOHIT ARORA, Frisco, TX (US); VINODKUMAR VASUDEV OTTAR, McKinney, TX (US); ADOLFO SANDOR MONTERO, Pflugerville, TX (US); LUIS ANTONIO VALENCIA REYES, Waxahachie, TX (US); RAJARAVI CHANDRA KOLLARAPU, Allen, TX (US)

(21) Appl. No.: 18/820,695

(22) Filed: Aug. 30, 2024

(51) Int. Cl. H04L 9/40; G06F 9/50

(52) U.S. Cl. CPC H04L 63/1416; G06F 9/5083; H04L 63/18; H04L 63/20

(57) ABSTRACT

Methods and systems for managing operation of a data processing system are disclosed. A management controller of the data processing system may identify an occurrence of an event for the data processing system that triggers a policy for the data processing system. A policy enforcement process may be performed based on the triggered policy. During performance of the policy enforcement process, environment data may be obtained by the management controller using a portion of hardware resources of the data processing system (e.g., a sensing device), and the environment data may be provided by the management controller to a remote system for analysis. To manage an outcome of the occurrence of the event and/or future occurrences of the event, an action set (based on the policy and/or the analysis of the environment data) may be performed.

### FIELD

Embodiments disclosed herein relate generally to managing operation of data processing systems. More particularly, embodiments disclosed herein relate to systems and methods to manage the operation of the data processing systems using environment data.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1A shows a block diagram illustrating a distributed system in accordance with an embodiment.

FIG. 1B shows a block diagram illustrating a data processing system in accordance with an embodiment.

FIGS. 2A-2B show interaction diagrams in accordance with an embodiment.

FIGS. 3A-3B show flow diagrams illustrating a method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of a data processing system. The data processing system may provide computer-implemented services. Provision of the computer-implemented services may include generation of, manipulation of, and/or other types of access to sensitive data (e.g., personal data, proprietary data). Thus, to manage the security of the data processing system (e.g., the sensitive data) while providing the computer-implemented services, policies may be put in places to reduce likelihoods of access to the data processing systems (e.g., the sensitive data) by entities unauthorized to do so.

For example, the policies may define circumstances (e.g., occurrences of events for the data processing system) and associated actions to perform in response to the circumstances. The occurrences of the events may increase a security risk for the data processing system. Therefore, during enforcement of the policies, the actions may be performed to improve outcomes associated with the occurrences of the events and/or occurrences of future events.

For example, during an occurrence of an event for the data processing system, enforcement of the policies may include performing actions to place the data processing system in a secure state (e.g., by updating operation of hardware and/or software components of the data processing system to reduce access to the sensitive data), and/or collecting and analyzing data (e.g., environment data) usable to manage outcomes of the occurrence of the event.

However, authentic and timely enforcement of the policies may rely on functionality of hardware resources (e.g., including software such as management entities hosted by the hardware resources) of the data processing system, which may be compromised during the occurrence of the event. For example, an attack on the data processing system by a malicious party may place the hardware resources in an undesired state. In the undesired state, for example, the hardware resources may be inoperable (e.g., unpowered, disconnected) and/or otherwise compromised. The malicious party may gain control of the hardware resources, for example, to interrupt policy enforcement (e.g., by modifying policies, by deactivating a policy response) and/or to prevent the collection of environment data (e.g., by depowering the hardware resources). As a result, environment data may not be collected timely, and the sensitive data may be at an increased risk of exposure to the malicious party and/or other unauthorized entities.

Thus, to improve policy enforcement and/or reliable collection of environment data, policies for the data processing system and enforcement thereof may be managed using out-of-band methods. To do so, the data processing system may include out-of-band components that may operate independently from in-band components (e.g., hardware resources) of the data processing system. The out-of-band components may remain operable even while the hardware resources (and/or software hosted thereon) are in an undesired state (e.g., compromised, unpowered) so that appropriate and authentic policies may be enforced, and outcomes of the occurrences of the events may be managed timely.

The out-of-band components may include functionality for power distribution to hardware resources of the data processing system, and functionality for communicating with remote systems over out-of-band communication channels (e.g., using a wireless wide area network) separate from in-band communication channels that service the in-band components.

For example, environment data may be collected as part of policy enforcement. The environment data may include any type of data usable to analyze and/or assess an environment in which the data processing system is present. The environment data may include video data, image data, thermal data, and/or other types of data that may be collected by sensing devices of the data processing system. Analysis of the environment data may yield information regarding people, objects, and/or activity occurring in the environment in order to facilitate investigation and/or auditing of the occurrence of the event. For example, the analysis may be performed to identify a malicious party, an intent of the malicious party, and/or other information for managing an outcome of the event or for managing future events (e.g., to reduce likelihoods of the future events occurring).

The out-of-band components may manage the collection of the environment data, and may provide the collected environment data to the remote systems automatically (e.g., in real-time) and surreptitiously from the in-band components. The analysis of the environment data (e.g., by the remote system and/or by the out-of-band components) may be used to guide responses to occurrences of events for the data processing system.

By doing so, security of the data processing system may be improved through timely and reliable detection of, reporting of, and/or responses to occurrences of events for the data processing system without relying on in-band components of the data processing system. As a result, sensitive data of the data processing system may be more likely to be protected while providing computer-implemented services, which may increase reliability and/or trustworthiness of the computer-implemented services.

In an embodiment, a method for managing operation of a data processing system is provided. The method may include: identifying, by a management controller of the data processing system, an occurrence of an event for the data processing system, the occurrence of the event triggering a policy for the data processing system; and, initiating, by the management controller, performance of a policy enforcement process based on the policy.

The performance of the policy enforcement process may include: obtaining, by the management controller, environment data using a portion of hardware resources of the data processing system; providing, by the management controller and via an out-of-band communication channel, the environment data to a management system; and, initiating, by the management controller, performance of an action set to manage an outcome of the occurrence of the event.

The method may further include obtaining, from the management system and via the out-of-band communication channel, an action of the action set.

The data processing system may include a network module adapted to separately advertise network endpoints for the management controller and the hardware resources, the network endpoints being usable by the management system to address communications to the hardware resources and the management controller. The out-of-band communication channel may run through the network module, and an in-band communication channel that services the hardware resources may also run through the network module.

Identifying the occurrence of the event may include: obtaining, by the management controller and from the network module, location data for the data processing system; and, analyzing the location data with respect to policies for the data processing system.

Identifying the occurrence of the event may include obtaining, by the management controller and via the out-of-band communication channel, a notification from the management system, the notification indicating the occurrence of the event.

The management controller and the network module may be on separate power domains from the hardware resources so that the management controller and the network module may be operable while the hardware resources are inoperable. The policy enforcement process may be performed while the hardware resources are in an undesired state.

The portion of the hardware resources may include a sensing device capable of sensing an environment in which the data processing system is present. The sensing device may include a camera. The sensing device may include a microphone. The sensing device may include a lid sensor.

A non-transitory media may include instructions that when executed by a processor cause the computer-implemented method to be performed.

The data processing system may include the non-transitory media and a processor, and may perform the computer-implemented method when the computer instructions are executed by the processor.

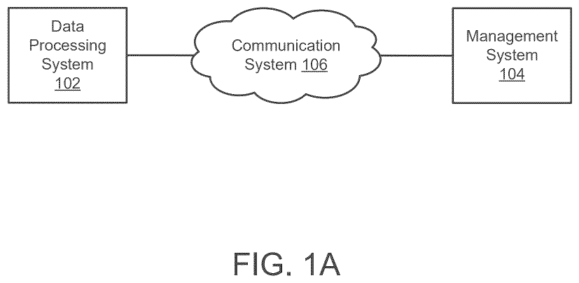

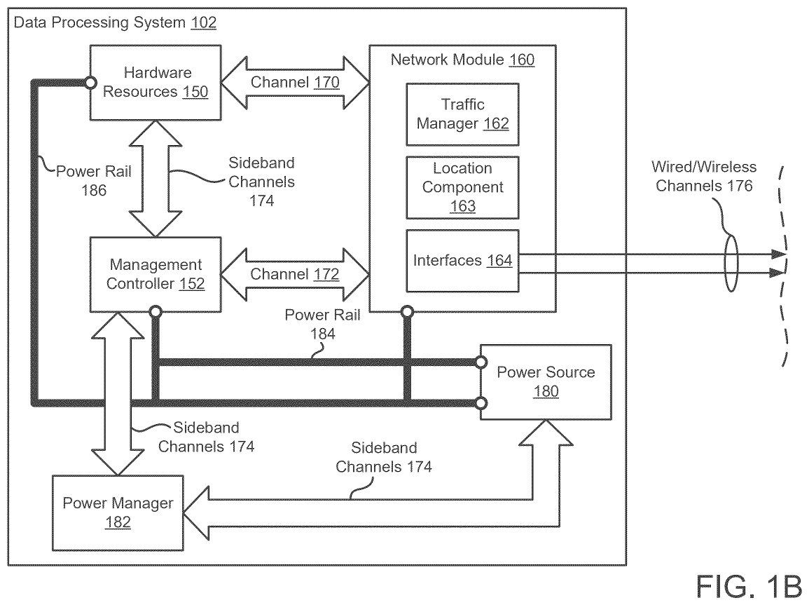

Turning to FIG. 1A, a block diagram illustrating a distributed system in accordance with an embodiment is shown. The system shown in FIG. 1A may provide computer-implemented services. The computer-implemented services may include any type and quantity of computer-implemented services. For example, the computer-implemented services may include communication services, data storage services, database services, data generation services, and/or any other type of service that may be implemented with a computing device.

The computer-implemented services may include sensitive computer-implemented services, wherein during provision of the sensitive computer-implemented services, sensitive data may be accessed, generated, and/or otherwise used. Sensitive data may include personal data, proprietary data, and/or other types of data that may be protected from exposure to unauthorized entities. To protect the sensitive data while providing the computer-implemented services, policies for the data processing system may be defined.

The policies may define barriers designed to reduce a likelihood of the data processing system being compromised in various circumstances. For example, the policies may include physical security policies (e.g., to reduce likelihoods of unauthorized physical access to the data processing systems and/or the sensitive data stored thereon), cybersecurity policies (e.g., for managing access to the sensitive data via passwords and/or other cryptographic means), geofencing policies (e.g., for managing different levels of access to the sensitive data when the data processing system is present in different geographical regions), and/or other types of policies for securing the data processing system (e.g., sensitive data) from unauthorized use.

However, despite efforts to reduce unauthorized access to the data processing system, security events for the data processing system may occur. For example, an attack may occur on the data processing system by a malicious party. The malicious party may gain access to the data processing system either physically (e.g., by bypassing physical security barriers) and/or virtually (e.g., by bypassing cybersecurity barriers via a compromised network connection). As a result, sensitive data stored by and/or accessible to the data processing system may be exposed to the malicious party and/or other unauthorized entities.

An occurrence of such an event may trigger a policy response for the data processing system. The policies may define actions that are to be performed to mitigate an outcome of the occurrence of the event. For example, the policies may define actions for placing the data processing system in various levels of secured states and/or actions for forensic data collection. The collected data may include environment data such as location data, image data, audio data, video data, and/or other types of data that may be recorded by the data processing system. The environment data may be used in subsequent investigation and/or auditing of the event in order to reduce impacts of the occurrence of the event and/or to prevent future similar events from occurring.

However, policy enforcement (e.g., the performance of such actions) may rely on functionality of hardware resources of the data processing system. For example, if the hardware resources are compromised (e.g., by the malicious party) and/or otherwise unavailable (e.g., powered off, disconnected), then the data processing system may be unable to respond to the occurrence of the event in accordance with the policies. For example, during an attack by the malicious party, policy response may be deactivated, portions of the hardware resources (e.g., sensing devices usable to collect environment data) may be deactivated, and/or any collected environment data may be tampered with. Consequently, sensitive data of the data processing system may be exposed and/or any subsequent investigation or auditing of the event using the environment data may be hindered.

In general, embodiments disclosed herein may provide methods, systems, and/or devices for managing security of a data processing system using environment data in a manner that reduces dependence on potentially unreliable hardware resources of the data processing. To do so, the data processing system may include out-of-band components that operate independently from in-band components (e.g., the hardware resources) of the data processing system. The out-of-band components may include functionality for identifying occurrences of events for the data processing system, and for managing policy enforcement for the occurrences of the events. For example, upon identification of an occurrence of an event, the out-of-band components may obtain environment data, provide the environment data to remote systems for analysis, and initiate actions for managing outcomes of the occurrences of the event even while the hardware resources are in an undesired (e.g., inoperable, compromised) state.

By doing so, the environment data may be made more reliable for use in (i) managing outcomes of occurrences of events (e.g., via performance of actions determined based on the environment data), and/or (ii) reducing a likelihood of future occurrences of events for the data processing system (e.g., through improved policy definition and/or via performance of preventative actions).

To provide the above-mentioned functionality, the distributed system of FIG. 1A may include data processing system 102, management system 104, and communication system 106. The distributed system, any components thereof, and/or any other types of devices or components not shown in FIG. 1A may perform all, or a portion of the computer-implemented services independently and/or cooperatively. Each of these components is discussed below.

Data processing system 102 may include any number of data processing systems. Data processing system 102 may be operated directly or indirectly (e.g., via other devices) by any number of users. For example, a user may operate data processing system 102 to obtain computer-implemented services, which may include sensitive computer-implemented services. Policies for protecting sensitive data of (e.g., stored by, accessible by, generated by) data processing system 102 may be enforced while providing the computer-implemented services.

Data processing system 102 may include hardware and/or software components. For example, data processing system 102 may include hardware resources usable to collect environment data, such as network cards, cameras, microphones, and/or other types of sensors that may be internal or external to data processing system 102. For example, data processing system 102 may include a laptop with a lid sensor, and the lid sensor may collect data indicating whether the lid is open or closed. The network cards may include functionality for obtaining and/or reporting location data for data processing system 102 (e.g., data indicating a location of data processing system 102) to other hardware resources, to out-of-band components, and/or to remote systems.

To manage policy enforcement, data processing system 102 may include out-of-band components, such as a management controller, capable of exchanging data with other devices via out-of-band communication channels. The out-of-band components may operate independently from the hardware resources. The out-of-band components may manage provisioning processes and policies for data processing system 102, as well as operation of portions of the hardware resources when enforcing policies of data processing system 102. Refer to the discussion of FIG. 1B for more information regarding components of data processing system 102.

To provide the above-mentioned functionality, the management controller may, for example, (i) obtain policies (e.g., from a remote system during a provisioning process for data processing system 102), (ii) monitor activity of data processing system 102 (e.g., obtain activity data, based on activity of the hardware resources and/or location data for data processing system 102), (iii) provide the activity data to remote systems via out-of-band communication channels, (iv) identify occurrences of events for data processing system 102 that trigger (at least one of) the policies (e.g., based on the activity data), (v) initiate performance of policy enforcement processes for data processing system 102, and/or (iv) perform other actions relating to managing operation of data processing system 102.

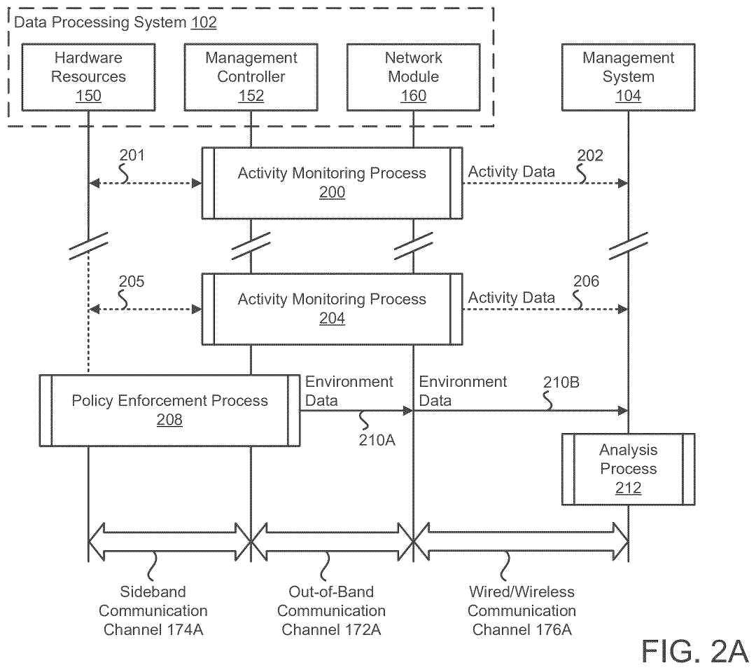

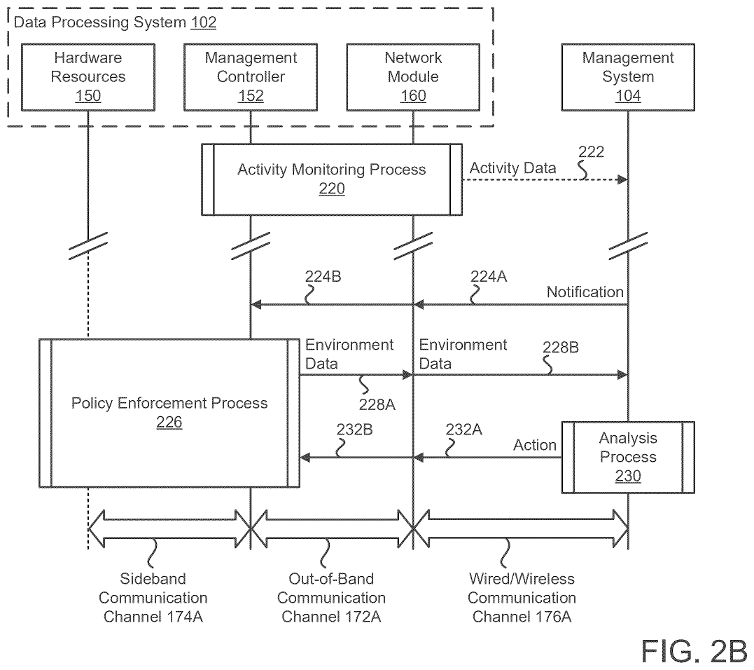

When enforcing policies, the management controller may (i) manage collection of (e.g., obtain) environment data for data processing system 102, (ii) provide the environment data to remote systems via out-of-band communication channels (e.g., for analysis of the environment data by the remote systems), (iii) obtain data (e.g., results of the analysis of the environment data, actions for performance) from the remote systems via the out-of-band communication channels, and/or (iv) initiate and/or perform other actions to manage outcomes of the occurrences of the events (e.g., actions defined by the policies, actions based on the analysis of the environment data). Refer to the discussion of FIGS. 2A-2B for examples of managing security of data processing system 102 through policy enforcement.

To participate in policy enforcement for data processing system 102, management system 104 may include any number and/or type of systems usable for providing management services for data processing system 102. For example, the management services may include provisioning services, remote management services, and/or data analysis services. To perform the services, management system 104 may communicate and/or exchange data with out-of-band components of data processing system 102 (e.g., the management controller), via the out-of-band communication channels.

For example, management system 104 may (i) provide notifications to the management controller regarding occurrences of events for data processing system 102, (ii) obtain and/or analyze data for data processing system 102 (e.g., activity data, environment data), (iii) obtain (e.g., generate) actions based on the data obtained for data processing system 102, and/or (iv) provide the actions to the management controller (e.g., for performance during policy enforcement processes).

By utilizing out-of-band methods for policy enforcement, occurrences of events for data processing system 102 may be more likely to be identified timely and responses to the occurrences of the events may be more likely to reduce negative impacts of the occurrences of the events.

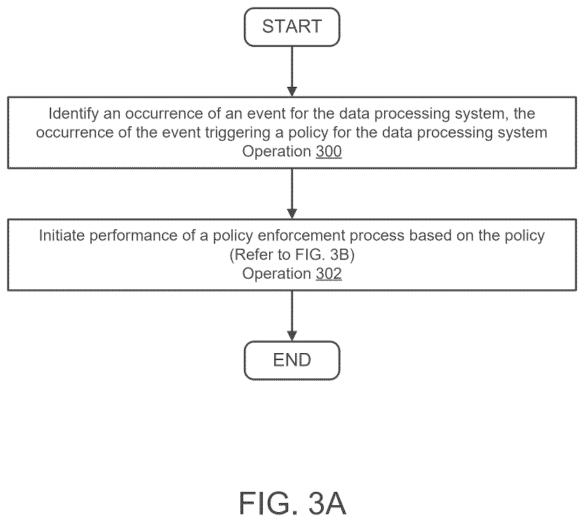

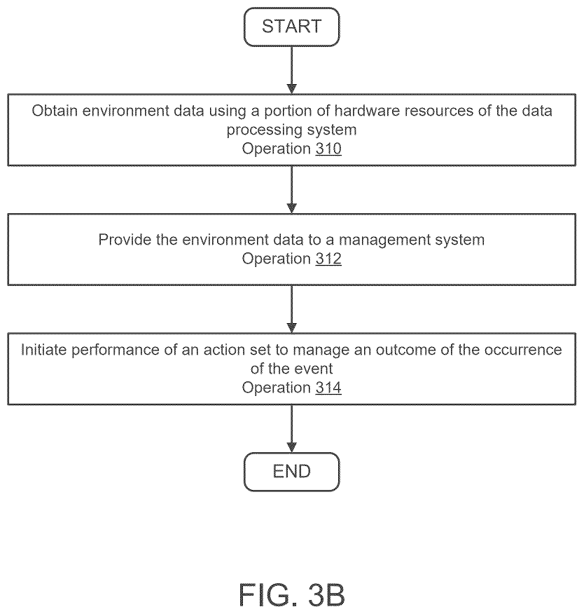

When providing their functionality, any of data processing system 102, management system 104, and/or components thereof may perform all, or a portion of the actions and methods illustrated in FIGS. 2A-3B.

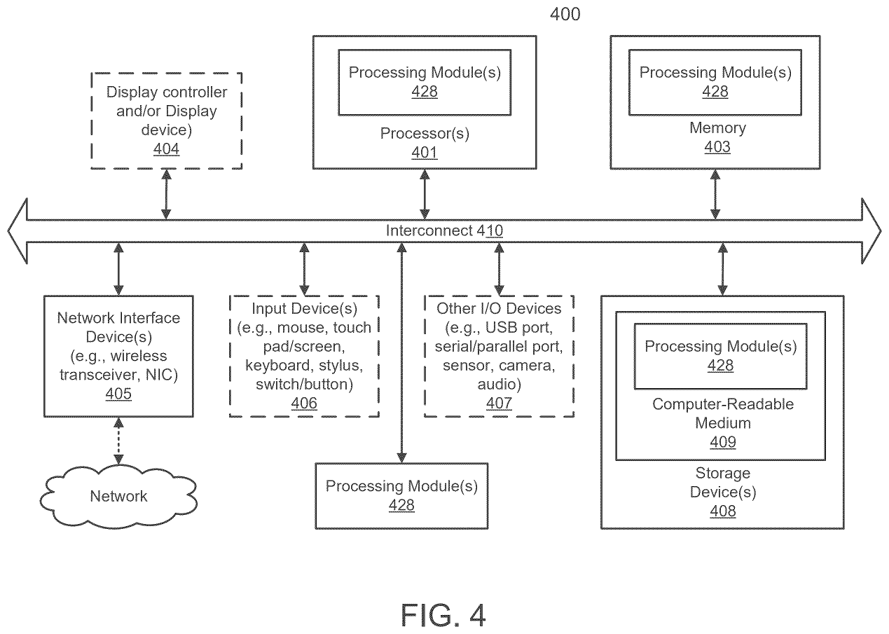

Any of data processing system 102 and management system 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., smartphone), an embedded system, local controllers, an edge node, and/or any other type of data processing device or system. For additional details regarding computing devices, refer to the discussion of FIG. 4.

Any of the components illustrated in FIG. 1A may be operably connected to each other (and/or components not illustrated) with communication system 106. Communication system 106 may facilitate communications between the components of FIG. 1A. In an embodiment, communication system 106 includes one or more networks that facilitate communication between any number of components. The networks may include wired networks and/or wireless networks (e.g., and/or the Internet). The networks and communication devices may operate in accordance with any number and types of communication protocols (e.g., such as the Internet protocol).

While illustrated in FIG. 1A as including a limited number of specific components, a system in accordance with an embodiment may include fewer, additional, and/or different components than those illustrated therein.

Turning to FIG. 1B, a diagram illustrating a data processing system in accordance with an embodiment is shown. Data processing system 102 shown in FIG. 1B may be similar to any of the computing devices shown in FIG. 1A.

To provide computer-implemented services, data processing system 102 may include any quantity of hardware resources 150. Hardware resources 150 may include components capable of sensing an environment in which data processing system 102 is present. For example, hardware resources 150 may include sensing devices such as cameras, microphones, switches, and/or other types of sensors (e.g., magnetic sensors, light sensors). The sensing devices may be internal and/or external to data processing system 102. Hardware resources 150 may be in-band (hardware) components, and may include a processor operably coupled to memory, storage, and/or other hardware components.

The processor may host various management entities such as operating systems, drivers, network stacks, and/or other software entities that provide various management functionalities. For example, the operating system and drivers may provide abstracted access to various hardware resources. Likewise, the network stack may facilitate packaging, transmission, routing, and/or other functions with respect to exchanging data with other devices.

For example, the network stack may support transmission control protocol/internet protocol communication (TCP/IP) (e.g., the Internet protocol suite) thereby allowing the hardware resources 150 to communicate with other devices via packet switched networks and/or other types of communication networks.

The processor may also host various applications that provide the computer-implemented services. The applications may utilize various services provided by the management entities and use (at least indirectly) the network stack to communicate with other entities.

However, use of the network stack and the services provided by the management entities may place the applications at risk of indirect compromise. For example, if any of these entities trusted by the applications are compromised, then these entities may subsequently compromise the operation of the applications. For example, if various drivers and/or the communication stack are compromised, then communications to/from other devices may be compromised. If the applications trust these communications, then the applications may also be compromised.

For example, to communicate with other entities, an application may generate and send communications to a network stack and/or driver, which may subsequently transmit a packaged form of the communication via channel 170 to a communication component, which may then send the packaged communication (in a yet further packaged form, in some embodiments, with various layers of encapsulation being added depending on the network environment outside of data processing system 102) to another device via any number of intermediate networks (e.g., via wired/wireless channels 176 that are part of the networks).

To reduce the likelihood of the applications and/or other in-band entities from being indirectly compromised, data processing system 102 may include management controller 152 and network module 160. Each of these components of data processing system 102 is discussed below.

Management controller 152 may be implemented, for example, using a system on a chip or other type of independently operating computing device (e.g., independent from the in-band components, such as hardware resources 150 of a host data processing system 102). Management controller 152 may provide various management functionalities for data processing system 102. Management controller 152 may, for example, monitor various ongoing processes performed by the in-band components, may manage power distribution, thermal management, and/or may perform other functions for managing data processing system 102. For example, management controller 152 may monitor activity of hardware resources 150 in order to detect occurrences of events for data processing system 102.

To do so, management controller 152 may be operably connected to various components via sideband channels 174 (in FIG. 1B, a limited number of sideband channels are included for illustrative purposes, it will be appreciated that management controller 152 may communicate with other components via any number of sideband channels such as 174A shown in FIGS. 2A-2B). The sideband channels may be implemented using separate physical channels, and/or with a logical channel overlay over existing physical channels (e.g., logical division of in-band channels). The sideband channels may allow management controller 152 to interface with other components and implement various management functionalities such as, for example, general data retrieval (e.g., to snoop ongoing processes), telemetry data retrieval (e.g., to identify a health condition/other state of another component), function activation (e.g., sending instructions that cause the receiving component to perform various actions such as displaying data, adding data to memory, causing various processes to be performed), and/or other types of management functionalities.

For example, to reduce the likelihood of indirect compromise of an application hosted by hardware resources 150, management controller 152 may enable information from other devices to be provided to the application without traversing the network stack and/or management entities of hardware resources 150. To do so, the other devices may direct communications including the information to management controller 152.

Management controller 152 may then, for example, send the information via sideband channels 174 to hardware resources 150 (e.g., to store it in a memory location accessible by the application, such as a shared memory location, a mailbox architecture, or other type of memory-based communication system) to provide it to the application. Thus, the application may receive and act on the information without the information passing through potentially compromised entities. Consequently, the information may be less likely to also be compromised, thereby reducing the possibility of the application becoming indirectly compromised. Similarly, processes may be used to facilitate outbound communications from the applications.

For example, when managing policy enforcement for data processing system 102, management controller 152 may provide instructions to hardware resources 150 via sideband channels 174. The instructions may include instructions for activating sensing devices of hardware resources 150 in order to facilitate collection of environment data.

Management controller 152 may be operably connected to communication components of data processing system 102 via separate channels (e.g., 172, 172A shown in FIGS. 2A-2B) from the in-band components, and may implement or otherwise utilize a distinct and independent network stack (e.g., TCP/IP). Consequently, management controller 152 may communicate with other devices independently of any of the in-band components (e.g., does not rely on any hosted software, hardware components, etc.). Accordingly, compromise of any of hardware resources 150 and hosted components may not result in indirect compromise of any management controller 152, and entities hosted by management controller 152.

For example, if hardware resources 150 are compromised as part of an attack on data processing system 102, then management controller 152 may continue to enforce policies by modifying operation of hardware resources 150 in a manner that may mitigate an outcome of the attack (e.g., placing data processing system 102 in a secure state, initiating collection of environment data).

To facilitate communication with other devices, data processing system 102 may include network module 160. Network module 160 may generate location data and/or provide communication services for in-band components and out-of-band components (e.g., management controller 152) of data processing system 102. To do so, network module 160 may include traffic manager 162, location component 163, and interfaces 164.

Traffic manager 162 may include functionality to (i) discriminate traffic directed to various network endpoints advertised by data processing system 102, and (ii) forward the traffic to/from the entities associated with the different network endpoints. For example, to facilitate communications with other devices, network module 160 may advertise different network endpoints (e.g., different media access control address/internet protocol addresses) for the in-band components and out-of-band components. Thus, other entities may address communications to these different network endpoints. When such communications are received by network module 160, traffic manager 162 may discriminate and direct the communications accordingly (e.g., over channel 170 or channel 172, in the example shown in FIG. 1B, it will be appreciated that network module 160 may discriminate traffic directed to any number of data units and direct it accordingly over any number of channels).

Accordingly, traffic directed to management controller 152 may never flow through any of the in-band components. Likewise, outbound traffic from the out-of-band component may never flow through the in-band components.

For example, when communicating with a remote system (e.g., management system 104), messages from the remote system may be addressed to a network endpoint advertised by network module 160 for out-of-band communications. The messages may include, for example, notifications of events occurring for data processing system 102, updated policies, actions (e.g., for performance by management controller 152 and/or hardware resources 150) and/or other information.

When messages are received by traffic manager 162, traffic manager 162 may forward the message to management controller 152 via an out-of-band communication channel (e.g., channel 172), differentiating the message from in-band communications to data processing system 102. By doing so, data processing system 102 may be more likely to obtain the messages even when hardware resources 150 are compromised and/or inoperable. Similarly, messages sent from management controller 152 (e.g., including activity data and/or environment data) to the remote system may be transmitted via the out-of-band communication channel to network module 160, bypassing the in-band components.

To support inbound and outbound traffic, network module 160 may include any number of interfaces 164. Interfaces 164 may be implemented using any number and type of communication devices which may each provide wired and/or wireless communication functionality. For example, interfaces 164 may include a wireless wide area network (WWAN) card, a Wi-Fi card, a wireless local area network card, a wired local area network card, an optical communication card, and/or other types of communication components. These components may support any number of wired/wireless channels 176 (e.g., wired/wireless communication channel 176A shown in FIGS. 2A-2B).

To generate location data, network module 160 may include location component 163. Location component 163 may include a global positioning system (GPS) receiver (e.g., for satellite-based geolocation), a cellular modem or chip (e.g., for cellular-based geolocation using a WWAN), sensors, and/or other types of geolocation components. Location component 163 may, for example, transmit and/or receive data across a network via interfaces 164 in order to generate (e.g., triangulate) a location of data processing system 102. The location data may be forwarded by traffic manager 162 to management controller 152 via an out-of-band communication channel (e.g., channel 172), bypassing potentially compromised and/or unavailable hardware resources 150.

Thus, location data for data processing system 102 may be generated and/or provided by network module 160 independently from hardware resources 150 (e.g., and software hosted by hardware resources 150). Network module 160 may provide location data generated by location component 163 to management controller 152 automatically based on a schedule, upon (automatic) detection of a change in location data (e.g., based on a displacement threshold), and/or upon obtaining a request for location data (e.g., from management controller 152).

Thus, from the perspective of an external device, the in-band components and out-of-band components of data processing system 102 may appear to be two independent network entities that may be independently addressable and/or otherwise unrelated to one another.

To facilitate management of data processing system 102 over time, hardware resources 150, management controller 152 and/or network module 160 may be positioned in separately controllable power domains. By being positioned in these separate power domains, different subsets of these components may remain powered while other subsets are unpowered.

For example, management controller 152 and network module 160 may remain powered while hardware resources 150 is unpowered. Consequently, management controller 152 may remain able to communicate with other devices even while hardware resources 150 are inactive. Similarly, management controller 152 may perform various actions while hardware resources 150 are in an undesired state (e.g., not powered and/or are otherwise inoperable, unable to cooperatively perform various process, are compromised, and/or are unavailable for other reasons).

Therefore, if hardware resources 150 are in an undesired state, then out-of-band components may remain powered in order to enforce policies for data processing system 102. For example, while hardware resources 150 are unpowered, power distribution may be managed so that management controller 152 may still (i) identify occurrences of events that trigger policies for data processing system 102, (ii) obtain environment data for data processing system 102, (iii) communicate with other devices (e.g., remote systems such as management system 104 and/or other systems) to provide the environment data to the other devices, (iv) initiate performance of actions usable to manage outcomes of the occurrence of the event, and/or (v) perform other actions for enforcing policies for data processing system 102.

To implement the separate power domains, data processing system 102 may include a power source (e.g., 180) that separately supplies power to power rails (e.g., power rail 184, power rail 186) that power the respective power domains. Power from the power source (e.g., a power supply, battery, etc.) may be selectively provided to the separate power rails to selectively power the different power domains. A power manager (e.g., 182) may manage power from power source 180, supplied via the power rails (e.g., by providing instructions via sideband channels 174). Management controller 152 may cooperate with power manager 182 to manage supply of power to these power domains. Management controller 152 may communicate with power manager 182 via sideband channels 174 and/or via other means.

In FIG. 1B, an example implementation of separate power domains using power rails 184-186 is shown. The power rails may be implemented using, for example, bus bars or other types of transmission elements capable of distributing electrical power. While not shown, it will be appreciated that the power domains may include various power management components (e.g., fuses, switches, etc.) to facilitate selective distribution of power within the power domains.

To further clarify embodiments disclosed herein, interaction diagrams in accordance with an embodiment are shown in FIGS. 2A-2B. The interaction diagrams may illustrate how data may be obtained and used within the system of FIGS. 1A-1B.

In the interaction diagrams, processes performed by and interactions between components of a (distributed) system in accordance with an embodiment are shown. In the diagrams, components of the system are illustrated using a first set of shapes (e.g., 150, 152, etc.), located towards the top of each figure. Lines descend from these shapes. Processes performed by the components of the system are illustrated using a second set of shapes (e.g., 200, 204) superimposed over these lines.

Interactions (e.g., communication, data transmissions, etc.) between the components of the system are illustrated using a third set of shapes (e.g., 202, 206) that extend between the lines. The third set of shapes may include lines terminating in one or two arrows. Lines terminating in a single arrow may indicate that one-way interactions (e.g., data transmission from a first component to a second component) occur, while lines terminating in two arrows may indicate that multi-way interactions (e.g., data transmission between two components) occur. Some of the third set of shapes are drawn in dashing to indicate that corresponding interactions are optional and/or may not occur (e.g., 201, 205).

Thick arrows (e.g., sideband communication channel 174A, out-of-band communication channel 172A, wired/wireless communication channel 176A) may indicate communication channels that facilitate multi-way interactions (e.g., data transmission between two components).

Generally, the processes and interactions are temporally ordered in an example order, with time increasing from the top to the bottom of each page. For example, the interaction labeled as 206 may occur prior to the interaction labeled as 210B. However, it will be appreciated that the processes and interactions may be performed in different orders, any may be omitted, and other processes or interactions may be performed without departing from embodiments disclosed herein.

Some of the lines descending from the first set of shapes are interrupted with line breaks. The line breaks may indicate, for example, a passage of time (e.g., between interactions and/or processes occurring above the line break and below other interactions and/or processes occurring below the line break), during which activity and/or events may occur.

Some portions of the lines descending from some of the first set of shapes (e.g., 150) are drawn in dashing to indicate, for example, that the corresponding components may be in an undesired state. For example, the corresponding components may be compromised and/or may not be (i) operable, (ii) powered on, (iii) present in the system, and/or (iv) participating in operation of the system for other reasons.

Turning to FIG. 2A, a first interaction diagram in accordance with an embodiment is shown. The first interaction diagram may illustrate processes and interactions that may occur during a first example of enforcing policies for a data processing system. The data processing system (e.g., data processing system 102) may include hardware resources 150, management controller 152, network module 160, and/or other components (not shown).

Prior to data processing system 102 arriving to an end user (e.g., after manufacturing), a provisioning process may be performed (not shown). During the provisioning process, policies may be provided to data processing system 102 using out-of-band methods. For example, management controller 152 may communicate with a remote provisioning system (e.g., management system 104) to obtain the policies and other types of provisioning data (e.g., software, configuration settings). The policies may be stored locally with management controller 152 and/or may be accessible to management controller 152. The policies may include security policies, geofencing policies, data collection and transmission policies, etc.

To enforce the policies, after the provisioning process is complete, management controller 152 may begin performing background processes such as activity monitoring processes. For example, management controller 152 may perform activity monitoring process 200 to obtain and/or analyze activity data for data processing system 102. The activity data may include location data and/or other data describing activity of hardware resources 150 (e.g., portions of system logs, event logs, change logs).

During activity monitoring process 200, network module 160 may generate the location data. Management controller 152 may obtain the location data from network module 160 via out-of-band communication channel 172A. To obtain other portions of the activity data, management controller 152 may (i) monitor activity of hardware resources 150 (e.g., snoop ongoing processes), (ii) obtain portions of activity data from hardware resources 150, and/or (iii) generate portions of the activity data (e.g., based on the snooped processes). For example, at interaction 201, management controller 152 may communicate with hardware resources 150 using sideband communication channel 174A when monitoring activity and/or obtaining data (e.g., log data) from storage of hardware resources 150.

During activity monitoring process 200, management controller 152 may analyze the activity data to identify events for the data processing system. For example, management controller 152 may compare the activity data to parameters and/or constraints defined by policies of data processing system 102 to determine whether a policy is triggered by activity of data processing system 102.

For example, a geofencing policy for data processing system 102 may be triggered if location data for data processing system 102 indicates that data processing system 102 is located outside of a geographical region defined by the geofencing policy (e.g., a geographical region inside which data processing system 102 is permitted to operate). Other types of policies may be triggered based on activity data. For example, the policies may specify certain functionality that is limited to specific geographical regions, maximum numbers of failed login attempts, activity data that may be related to network attacks, and/or other information that may trigger a policy response. In the example shown in FIG. 2A, data processing system 102 may be operating in accordance with the policies during activity monitoring process 200 and therefore no policy may be triggered.

At interaction 202, the activity data may be provided to management system 104 by management controller 152 (e.g., via network module 160). For example, the activity data may be generated by management controller 152 and provided over out-of-band communication channel 172A to network module 160. Network module 160 may forward the activity data to management system 104 via wired/wireless communication channel 176A (e.g., using a network such as a WWAN) via (i) transmission via a message, (ii) storing in a storage with subsequent retrieval by management system 104, (iii) a publish-subscribe system where management system 104 subscribes to updates from management controller 152 thereby causing a copy of the activity data to be propagated to management system 104, and/or (iv) other processes.

By providing the activity data to management system 104, management system 104 may analyze and/or store the activity data (e.g., in a repository). For example, analysis of the activity data may be performed by management system 104 as well as (or instead of) by management controller 152. Management controller 152 may provide activity data to management system 104 periodically over time (e.g., based on a schedule, based on detected changes in the activity data, etc.).

During analysis of the activity data, location data for data processing system 102 may monitored (e.g., track and/or map) over time. Management system 104 may store location history of data processing system 102. Other devices may use an application hosted by management system 104 to track locations of data processing system 102 over time. Management system 104 may have access to policies for data processing system 102 and may notify management controller 152 and/or other entities when any of the policies are triggered based on the activity data.

The line breaks occurring after interaction 202 may indicate the passage of a period of time during which an event may occur. For example, the dashing line below the line break in the line descending from hardware resources 150 may indicate that, during the period of time, hardware resources 150 were placed in an undesired state (e.g., compromised, inoperable, unpowered, compromised, and/or may otherwise not be participating in operation of data processing system 102).

In the example shown in FIG. 2A, the event may include data processing system 102 leaving a defined geographical region. For example, during the period of time, data processing system 102 may be moved from a first location inside a first geographical region in which data processing system 102 is authorized to operate, to a second location inside a second geographical region in which data processing system 102 is not authorized to operate. Occurrence of the event may be detected during activity monitoring process 204.

Activity monitoring process 204 may be similar to activity monitoring process 200. For example, interaction 205 may be similar to interaction 201, and interaction 206 may be similar to interaction 202. During activity monitoring process 204, activity data (obtained after the occurrence of the event) may be analyzed in view of policies for data processing system 102. The activity data may indicate that data processing system 102 is not located inside a geographical region in which operation of data processing system 102 is authorized, which may trigger a geofencing policy for data processing system 102. Thus, the analysis of the activity data may cause management controller 152 to identify the occurrence of the event.

Upon identification of the event, management controller 152 may initiate performance of a policy enforcement process to enforce the geofencing policy. Management controller 152 may perform policy enforcement process 208 while hardware resources 150 are in the undesired state. Portions of policy enforcement process 208 may be performed by hardware resources 150 and management controller 152 cooperatively and/or independently.

During policy enforcement process 208, actions specified by and/or based on the policy may be performed. To initiate performance of the actions, management controller 152 may provide instructions to hardware resources 150 (e.g., via sideband communication channel 174A) and/or management controller 152 may execute other instructions.

For example, the policy may specify that, upon occurrence of the particular event, management controller 152 is to issue and/or execute instructions for updating operation of hardware resources 150. The instructions may, for example, limit functionality of hardware resources 150 (e.g., to place data processing system 102 in a secure state), modify (e.g., remove, overwrite) sensitive data stored on data processing system 102, and/or to activate functionality of hardware resources 150 (e.g., initiate collection of environment data). Updating the operation of hardware resources 150 may place hardware resources in a desired state (e.g., a secure state, or a state specified by the geofencing policy).

As discussed with respect to FIGS. 1A-1B, hardware resources 150 may include sensing devices such as microphones, cameras, lid sensors, and/or other types of sensors. Therefore, activating functionality of hardware resources 150 may include instructing sensing devices of data processing system 102 to begin (or continue) collecting environment data.

For example, a camera of data processing system 102 may begin recording video and/or obtaining images of an environment in which data processing system 102 is present. The camera may be activated, for example, when the lid sensor obtains data indicating that the lid is open, when the camera detects motion, when keyboard sensors indicate that a user has interacted with the keyboard, and/or when activity data indicates that a login attempt is being made. However, a microphone of data processing system 102 may be activated to collect audio data regardless of the lid sensor data, the keyboard sensor data, and/or the activity data.

Other types of environment data may be collected during policy enforcement process 208. For example, during policy enforcement process 208, management controller 152 may provide instructions to hardware resources 150 (e.g., via sideband communication channel 174A) for executing key logging software and/or to obtain data keyboard sensor data. Any type of environment data may be collected using any sensing device (e.g., internal or external to data processing system 102) during policy enforcement process 208.

Management controller 152 may initiate the collection of the environment data by managing power distribution for hardware resources 150 (e.g., by instructing power manager 182 to provide power to portions of hardware resources 150 (e.g., a sensing device) and other components required for collecting the type(s) of environment data specified by the policy. Thus, while hardware resources 150 are in the undesired state, management controller 152 may remain available (e.g., operable, powered, uncompromised, etc.) and may continue to provide environment data to management system 104 independently from the hardware resources 150. For example, if hardware resources 150 are unpowered, then hardware resources 150 may not be able to obtain and/or provide up to date (e.g., current) environment data to management system 104.

For example, if hardware resources 150 are compromised by a malicious party, then the malicious party may be able to intercept and/or modify the environment data before analysis (e.g., by management system 104). Therefore, by obtaining and/or providing the environment data for data processing system 102 using out-of-band methods (e.g., by management controller 152 and via out-of-band communication channel 172A), the environment data may be more reliably obtained and provided to management system 104 than when using in-band methods (e.g., using hardware resources 150 and in-band communication channels).

The environment data obtained during policy enforcement process 208 may include information usable investigate environments in which data processing system 102 is located (e.g., a present environment of data processing system 102). For example, the environment data may include information (e.g., video, images) regarding a current user of data processing system 102. Upon analysis of the environment data, the current user may be identified as an unauthorized (e.g., malicious) entity with unauthorized access to data processing system 102. Or, the current user may be identified as an authorized user of data processing system 102 that has potentially unknowingly violated the geofencing policy. Thus, the environment data may include information usable to appropriately manage the occurrence of the event, to improve policies for other data processing systems of a deployment, and/or to otherwise investigate the occurrence of the event.

At interactions 210A and 210B, the environment data may be provided to management system 104 by management controller 152 (e.g., via network module 160). For example, the environment data may be provided over out-of-band communication channel 172A to network module 160 (interaction 210A), and over wired/wireless communication channel 176A to management system 104 (interaction 210B) via (i) transmission via a message, (ii) storing in a storage with subsequent retrieval by management system 104, (iii) a publish-subscribe system where management system 104 subscribes to updates from management controller 152 thereby causing a copy of the environment data to be propagated to management system 104, and/or (iv) other processes. By providing the environment data to management system 104, management system 104 may perform data analysis services.

To perform the data analysis services, management system 104 may perform analysis process 212. During analysis process 212, the environment data and any activity data for data processing system 102 (e.g., provided to management system 104 over time by management controller 152) may be analyzed. For example, the environment data (and activity data) may be analyzed to investigate and/or audit the occurrence of the event. For example, the analysis may include identifying root causes (e.g., via root cause analysis) and/or identifying actions (e.g., present actions, future actions) for managing an outcome of the occurrence of the event.

In a first example of the occurrence of the event, an authorized user may have inadvertently violated the geofencing policy. Based on the analysis of the environment data (e.g., using recorded video and/or audio to identify the authorized user), the occurrence of the event may be classified as a low-risk event, and management system 104 may generate a notification of the policy violation for the user and/or another entity (e.g., an administrator).

The notification may be provided via management controller 152 via out-of-band methods and/or to other entities using other methods (not shown). Based on the notification, management controller 152 may instruct software hosted by hardware resources 150 to generate a pop-up to notify the user of the policy violation and any consequences of the violation. The notification may instruct management controller 152 to invoke other policies for updating operation of data processing system 102 in view of the policy violation by the authorized user. For example, management controller 152 may perform actions to limit some functionality of data processing system 102.

In a second example of the occurrence of the event, an unauthorized user may have violated the geofencing policy by relocating data processing system 102, and may be in possession of data processing system 102. Based on the analysis of the environment data, the unauthorized user may be identified as such, and the occurrence of the event may be classified as a high-risk event. Management system 104 may identify actions for notifying various entities (e.g., an administrator, authorized users) of the occurrence of event and/or actions for remediation of the event by management controller 152. For example, the actions for remediation may be provided to management controller 152 via out-of-band communication channel 172A (not shown). The actions for remediation may include actions for limiting all functionality of data processing system 102.

Turning to FIG. 2B, a second interaction diagram in accordance with an embodiment is shown. The second interaction diagram may illustrate processes and interactions that may occur during a second example of enforcing policies for a data processing system. As discussed with respect to FIG. 2A, data processing system 102 may have undergone a provisioning process where policies are loaded to management controller 152 and/or hardware resources 150.

To enforce the policies, management controller 152 may perform activity monitoring process 220 to obtain and/or analyze activity data. Activity monitoring process 220 may be similar to the activity monitoring processes described with respect to FIG. 2A (e.g., 202, 204). During activity monitoring process 220 and at interaction 222, management controller 152 may provide activity data to management system 104. Interaction 222 may be similar to interactions 202 and 206 of FIG. 2A.

As discussed above, the line breaks (occurring after interaction 222) may indicate the passage of a period of time during which an event may occur. In the example shown in FIG. 2B, the event may include a user of data processing system 102 reporting data processing system 102 lost and/or stolen. For example, the user may use another device running an application hosted by management system 104 to generate the report, and/or an administrator may generate the report based on information obtained from the user, using the same or a similar application.

Management system 104 may use the report (e.g., information included in the report, such as an identifier for data processing system 102) to identify management controller 152. For example, management controller 152 may be pre-registered with management system 104 as an out-of-band component for data processing system 102. Upon identifying management controller 152, management system may generate and provide a notification indicating occurrence of the event to management controller 152.

At interactions 224A and 224B, the notification may be provided to management controller 152 by management system 104 (e.g., via network module 160). For example, the notification may be provided over wired/wireless communication channel 176A to network module 160 (interaction 224A), and forwarded by network module 160 over out-of-band communication channel 172A to management controller 152 (interaction 224B) via (i) transmission via a message, (ii) storing in a storage with subsequent retrieval by management controller 152, (iii) a publish-subscribe system where management controller 152 subscribes to updates from management system 104 thereby causing a copy of the notification to be propagated to management controller 152, and/or (iv) other processes. Upon obtaining the notification, management controller 152 may read the notification and identify occurrence of the event. A policy of data processing system 102 may be keyed to the occurrence of the event; therefore, the policy may be triggered.

In response to the policy being triggered, management controller 152 may enforce the triggered policy for data processing system 102 by initiating policy enforcement process 226. Policy enforcement process 226 may be similar to policy enforcement process 208 of FIG. 2A. For example, during policy enforcement process 226, management controller 152 may initiate and/or perform an action set that may include actions for updating operation of data processing system 102, and actions for enforcing the triggered policy. The actions may be defined by and/or based on the triggered policy. Specifically, by enforcing the triggered policy, management controller 152 may initiate and/or otherwise manage collection of environment data for data processing system 102. See policy enforcement process 208 of FIG. 2A for more details regarding environment data.

At interactions 228A and 228B, the environment data may be provided to management system 104 as described with respect to interactions 210A and 210B of FIG. 2A. By providing the environment data to management system 104, management system 104 may investigate and/or audit the occurrence of the event by performing analysis process 230. Analysis process 230 may be similar to analysis process 212 of FIG. 2A. For example, during analysis process 230, activity data and/or environment data may be analyzed to improve policies (e.g., in case of future occurrences of similar events) and/or obtain actions for managing the occurrence of the event and/or outcomes thereof.

Any policies (e.g., new policies, improved policies) and/or actions generated during analysis process 230 may be provided to management controller 152 at interactions 232A and 232B (similar to interactions 224A and 224B). Some portions of the actions provided to management controller 152 may supersede and/or be in addition the actions initiated and/or performed by management controller 152 based on the triggered policy. For example, if during analysis process 230 it is determined that, based on the environment data, the occurrence of the event is likely to result in a catastrophic outcome (e.g., based on some scale of outcomes), then an action generated by management system 104 may include damaging critical hardware components of hardware resources 150 to protect sensitive data. This action may supersede and/or be in addition to other actions defined by the triggered policy, such as removing sensitive data from data processing system 102.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

Thus, using processes and interactions shown in FIGS. 2A-2B, as part of policy enforcement for a data processing system, environment data may be obtained and provided to remote systems, regardless of a state of hardware resources of the data processing system, using out-of-band methods. By using the out-of-band methods, policies triggered by occurrences of events may be more likely to be enforced. For example, environment data may be more likely to be collected and analyzed in real-time, and the environment data may be used to improve and/or customize actions for managing outcomes of the occurrences of the events.

Turning to FIG. 3A, a first flow diagram illustrating a method in accordance with an embodiment is shown. The first flow diagram may illustrate various operations performed while managing operation of a data processing system using environment data.

At operation 300, an occurrence of an event for the data processing system may be identified. In a first example, the occurrence of the event may be identified by (i) obtaining location data for the data processing system, and (ii) analyzing the location data with respect to policies for the data processing system. For example, the location data may be obtained by a management controller of the data processing system from a network module of the data processing system.

Obtaining the location data may include (i) receiving the location data (e.g., by the management controller and from the network module over an out-of-band communication channel), (ii) reading the location data from storage, and/or (iii) generating the location data. For example, the location data may be generated by the network module as discussed with respect to FIG. 1B.

Analyzing the location data may include (i) obtaining a location for the data processing system based on the location data, and (ii) mapping the location with respect to geological regions defined by policies (e.g., geofencing policies) of the data processing system. For example, the occurrence of the event may include a location of the data processing system being outside of a geological region defined by a geofencing policy for the data processing system. The occurrence of the event may trigger the geofencing policy.

In a second example, the occurrence of the event may be identified by obtaining a notification from a management system. The notification may be obtained via methods discussed with respect to FIG. 2B (e.g., interactions 224A and 224B). The notification may indicate the occurrence of the event; therefore, the management controller may obtain the notification and read the notification to identify the occurrence of the event. For example, the notification may indicate that the data processing system is lost and/or stolen, and the occurrence of the event may trigger a security policy for the data processing system.

At operation 302, performance of a policy enforcement process may be initiated based on the policy. For example, the management controller may initiate performance of the policy enforcement process by (i) obtaining instructions for performing actions specified by and/or based on the policy, (ii) executing a first portion of the instructions, and/or (iii) providing a second portion of the instructions to the hardware resources via a sideband communication channel.

Performance of the policy enforcement process may include (i) obtaining environment data for the data processing system, (ii) providing the environment data to the management system, and/or (iii) initiating performance of an action set to manage an outcome of the occurrence of the event. Refer to FIG. 3B for additional details regarding performance of the policy enforcement process. for more details regarding the policy enforcement process.

The method may end following operation 302.

Turning to FIG. 3B, a second flow diagram illustrating a method in accordance with an embodiment is shown. The second flow diagram may illustrate various operations performed while performing a policy enforcement process for a data processing system. The operations shown in FIG. 3B may be an expansion of operation 302 of FIG. 3A. For example, the data processing system may have experienced an occurrence of an event that triggered a policy of the data processing system. In response to the occurrence of the event, the policy enforcement process may have been initiated.

At operation 310, environment data for the data processing system may be obtained using a portion of hardware resources of the data processing system. For example, a management controller may obtain the environment data by (i) receiving the environment data (e.g., from sensing devices of the hardware resources via a sideband communication channel of the data processing system), (ii) reading the environment data from storage (e.g., local storage, storage of the hardware resources), and/or (iii) generating the environment data.

For example, the environment data may be generated by activating a sensing device such as a camera, a microphone, and/or other types of sensors (e.g., a lid sensor, a thermal sensor). To do so, management controller may (i) provide instructions to a power manager of the data processing system instructing the power manager to distribute power to the sensing device (and/or other components of the data processing system), and/or (ii) provide instructions to the sensing device for activating functionality of the sensing device. The instructions may be provided via a sideband communication channel of the data processing system.

At operation 312, the environment data may be provided to a management system. The environment data may be provided to the management system using methods similar to those described with respect to interactions 210A and 210B of FIG. 2A and/or by other methods. For example, the management controller may provide the environment data to the management system via an out-of-band communication channel of the data processing system.

At operation 314, performance of an action set may be initiated to manage an outcome of the occurrence of the event. The performance of the action set may be initiated by (i) obtaining actions of the action set, (ii) obtaining instructions based on the actions, and/or (iii) making the instructions available for execution.

Obtaining actions of the action set may include (i) querying the policy (e.g., triggered by the occurrence of the event), and/or (ii) obtaining actions from the management system (e.g., actions determined based on an analysis of the environment data). For example, the management controller may initiate performance of the action set by (i) obtaining an action of the action set from the management system via an out-of-band communication channel of the data processing system, (ii) executing a first portion of instructions based on the action set, and/or (iii) providing a second portion of the instructions (e.g., based on the action set) to the hardware resources for execution by a portion of the hardware resources. The instructions may be provided to the hardware resources from the management controller via a sideband channel of the data processing system connecting the hardware resources and the management controller.

Performance of the action set may update operation of the data processing system (e.g., place the data processing system in a desired state), and/or a state that facilitates providing computer-implemented services in accordance with policies of the data processing system.

The method may end following operation 314.

Thus, as illustrated above, embodiments disclosed herein may provide systems and methods for improving usability of environment data obtained when enforcing policies of a data processing system. The usability of the environment data may be improved by facilitating real-time collection and provision of the environment data to remote systems for analysis. Policy enforcement, including the collection of environment data, may be managed using out-of-band methods, increasing a likelihood of timely policy enforcement even when hardware resources of the data processing system are compromised and/or otherwise unavailable. By doing so, the environment data may be more likely to be reliable for improving security of the data processing system.

Any of the components illustrated in FIGS. 1A-3B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as Vx Works.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs, or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a data processing system, the method comprising:
identifying, by a management controller of the data processing system, an occurrence of an event for the data processing system, the occurrence of the event triggering a policy for the data processing system; and
initiating, by the management controller, performance of a policy enforcement process based on the policy, the performance of the policy enforcement process comprising:
obtaining, by the management controller, environment data using a portion of hardware resources of the data processing system,
providing, by the management controller and via an out-of-band communication channel, the environment data to a management system, and
initiating, by the management controller, performance of an action set to manage an outcome of the occurrence of the event.

2. The method of claim 1, further comprising:
obtaining, from the management system and via the out-of-band communication channel, an action of the action set.

3. The method of claim 1, wherein the data processing system comprises a network module adapted to separately advertise network endpoints for the management controller and the hardware resources, the network endpoints being usable by the management system to address communications to the hardware resources and the management controller.

4. The method of claim 3, wherein the out-of-band communication channel runs through the network module, and an in-band communication channel that services the hardware resources also runs through the network module.

5. The method of claim 4, wherein identifying the occurrence of the event comprises:
obtaining, by the management controller and from the network module, location data for the data processing system; and
analyzing the location data with respect to policies for the data processing system.

6. The method of claim 4, wherein identifying the occurrence of the event comprises:
obtaining, by the management controller and via the out-of-band communication channel, a notification from the management system, the notification indicating the occurrence of the event.

7. The method of claim 4, wherein the management controller and the network module are on separate power domains from the hardware resources so that the management controller and the network module are operable while the hardware resources are inoperable.

8. The method of claim 1, wherein the policy enforcement process is performed while the hardware resources are in an undesired state.

9. The method of claim 1, wherein the portion of the hardware resources comprises a sensing device capable of sensing an environment in which the data processing system is present.

10. The method of claim 9, wherein the sensing device comprises a camera.

11. The method of claim 9, wherein the sensing device comprises a microphone.

12. The method of claim 9, wherein the sensing device comprises a lid sensor.

13. A non-transitory machine-readable medium having instructions stored therein, which when executed by a processor, cause the processor to perform operations for managing operation of a data processing system, the operations comprising:
identifying, by a management controller of the data processing system, an occurrence of an event for the data processing system, the occurrence of the event triggering a policy for the data processing system; and
initiating, by the management controller, performance of a policy enforcement process based on the policy, the performance of the policy enforcement process comprising:
obtaining, by the management controller, environment data using a portion of hardware resources of the data processing system,
providing, by the management controller and via an out-of-band communication channel, the environment data to a management system, and
initiating, by the management controller, performance of an action set to manage an outcome of the occurrence of the event.

14. The non-transitory machine-readable medium of claim 13, wherein the operations further comprise:
obtaining, from the management system and via the out-of-band communication channel, an action of the action set.

15. The non-transitory machine-readable medium of claim 13, wherein the data processing system comprises a network module adapted to separately advertise network endpoints for the management controller and the hardware resources, the network endpoints being usable by the management system to address communications to the hardware resources and the management controller.

16. The non-transitory machine-readable medium of claim 15, wherein the out-of-band communication channel runs through the network module, and an in-band communication channel that services the hardware resources also runs through the network module.

17. A data processing system, comprising:
a processor; and
a memory coupled to the processor to store instructions, which when executed by the processor, cause operations for managing the data processing system to be performed, the operations comprising:
identifying, by a management controller of the data processing system, an occurrence of an event for the data processing system, the occurrence of the event triggering a policy for the data processing system, and
initiating, by the management controller, performance of a policy enforcement process based on the policy, the performance of the policy enforcement process comprising:
obtaining, by the management controller, environment data using a portion of hardware resources of the data processing system;
providing, by the management controller and via an out-of-band communication channel, the environment data to a management system; and
initiating, by the management controller, performance of an action set to manage an outcome of the occurrence of the event.

18. The data processing system of claim 17, wherein the operations further comprise:
obtaining, from the management system and via the out-of-band communication channel, an action of the action set.

19. The data processing system of claim 17, further comprising:
a network module adapted to separately advertise network endpoints for the management controller and the hardware resources, the network endpoints being usable by the management system to address communications to the hardware resources and the management controller.

20. The data processing system of claim 19, wherein the out-of-band communication channel runs through the network module, and an in-band communication channel that services the hardware resources also runs through the network module.
